(19) United States
(12) Patent Application Publication
(10) Pub. No.: US 2007/0038958 A1
(43) Pub. Date: Feb. 15, 2007

(54) Item selection device and item selection method

(75) Inventor: Makoto Gohda, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/498,112

(22) Filed: Aug. 3, 2006

(30) Foreign Application Priority Data
Aug. 11, 2005 (JP) 2005-233338

(51) Int. Cl. H04N 5/44

(52) U.S. Cl. 715/823; 715/716

(57) ABSTRACT

The present invention intends to allow a user to intuitively select still image data extracted from moving image data, the extracted still image data being arranged in order based on times at which they are recorded and being displayed in a list view on a display device. A first plurality of still image data are selected from the extracted still image data, and it is displayed that the first plurality of still image data are in a first selected state. A second still image data is selected from the first plurality of still image data, and it is displayed that the second still image data is in a second selected state. The first selected state of at least one of the first plurality of still image data arranged before and at least one of the first plurality of still image data arranged after the selected second still image data are cancelled.

### BACKGROUND OF THE INVENTION

1. Field of the Invention

The present invention relates to a technique for allowing a particular item to be selected from a plurality of items such as image files which are arranged and displayed on a computer screen.

2. Description of the Related Art

An operation for handling image data on a computer screen have become common. For example, a user stores still image data taken with a digital camera as a still image file in a hard disk drive of a computer, and performs an operation which selects an arbitrary file from a plurality of still image files stored in such a way. In addition, the user performs an operation which specifies a certain operation (for example, printing) with respect to such a selected still image file.

Further, as another trend, it is noted that in accordance with recent advances in computer performance and media capacity, the amount of still image data that can be handled is increasing greatly. For example, in Japanese Patent Laid-Open No. 2005-027021, it is described that still image data is extracted from moving image data on a computer and then stored; still image data thus obtained is a typical example of large amount of data.

In this case, as a method for selecting a plurality of items which will become objects of the next operation from a plurality of items such as still image data displayed on the computer screen, a method which specifies desired items desired to be selected one at a time is used. Additionally, a method which specifies a head and a tail end of items desired to be selected thereby selecting all items between them is also used.

However, in the method which specifies an object to be selected one at a time, its operation is complicated and impractical when there are many items to be selected. On the other hand, the method which specifies a head and a tail end of items desired to be selected and thereby selects all items between them has been conceived basically assuming that an item in a deselected state is put into a selected state. Because of this, a problem arises out of the difficulty of intuitively identifying a desired item desired to be selected from among many items, and this problem leads to a decrease in usability.

### SUMMARY OF THE INVENTION

The present invention is made in view of the described problem above, and intends to realize a technique which allows more intuitive recognition and efficient selection of an item when the item desired to be selected is specified from many items.

To solve the above described problem and achieve the object, the present invention provides an item selection device which allows a particular item to be selected from a plurality of items arranged in a predetermined sequence and displayed on a display device, comprising a first selection unit configured to select a first plurality of items from a plurality of items, a first display unit configured to display that the first items are in a first selected state selected by the first selection unit, a second selection unit configured to select a second item from the first items, a second display unit configured to display that the second item is in a second selected state selected by the second selection unit, and a cancellation unit configured to cancel the first selected state of first items arranged at least one of before and after the second item selected by the second selection unit.

In addition, the present invention provides an item selection method for selecting an item from a plurality of items arranged and displayed on a display device, comprising the steps of selecting a first plurality of items; displaying that the first items are in a first selected state on the display device; selecting a second item from the first items; displaying that the second item is in a second selected state on the display device; and canceling the first selected state of first items arranged at least one of before and after the selected second item.

In addition, the present invention provides a computer readable storage medium which stores a program for allowing a computer to perform the above mentioned method for selecting the item from the plurality of items arranged and displayed on a display device and a computer program product stored on a computer-readable memory medium and embodying a computer-executable program for implementing the above mentioned method for selecting the item from the plurality of items arranged and displayed on a display device

According to the present invention, a particular item is allowed to be intuitively and efficiently selected from many items.

Further features of the present invention will become apparent from the following description of exemplary embodiments (with reference to the attached drawings).

### BRIEF DESCRIPTION OF THE DRAWINGS

FIG. 1 is a block diagram which shows a hardware configuration of an embodiment for implementing the present invention;

FIG. 2 is a flowchart which shows a selection operation of a first embodiment according to the present invention;

FIG. 3 is a diagram for illustrating a user interface screen (1) in the selection operation of the first embodiment;

FIG. 4 is a diagram for illustrating a user interface screen (2) in the selection operation of the first embodiment;

FIG. 5 is a diagram for illustrating a user interface screen (3) in the selection operation of the first embodiment;

FIG. 6 is a diagram for illustrating a user interface screen (4) in the selection operation of the first embodiment;

FIG. 7 is a diagram for illustrating a user interface screen (5) in the selection operation of the first embodiment;

FIG. 8 is a diagram for illustrating a user interface screen (6) in the selection operation of the first embodiment;

FIG. 9 is a diagram for illustrating a user interface screen (7) in the selection operation of the first embodiment;

FIG. 10 is a flowchart which shows a selection operation of a second embodiment according to the present invention;

FIG. 11 is a diagram for illustrating a user interface screen (1) in the selection operation of the second embodiment;

FIG. 12 is a diagram for illustrating a user interface screen (2) in the selection operation of the second embodiment;

FIG. 13 is a diagram for illustrating a user interface screen (3) in the selection operation of the second embodiment;

FIG. 14 is a flowchart which shows a selection operation of a third embodiment according to the present invention;

FIG. 15 is a diagram for illustrating a user interface screen (1) in the selection operation of the third embodiment;

FIG. 16 is a diagram for illustrating a user interface screen (2) in the selection operation of the third embodiment;

FIG. 17 is a diagram for illustrating a user interface screen (3) in the selection operation of the third embodiment;

FIG. 18 is a diagram for illustrating a user interface screen (4) in the selection operation of the third embodiment;

FIG. 19 is a diagram for illustrating a user interface screen (5) in the selection operation of the third embodiment; and

FIG. 20 is a diagram for illustrating a user interface screen (6) in the selection operation of the third embodiment.

### DESCRIPTION OF THE EMBODIMENTS

Hereinafter, one embodiment according to the present invention will be described with reference to accompanying drawings.

An embodiment as will be described below is one example for realizing the present invention, and should be modified or changed as needed depending on a structure of a device to which the present invention applies or various conditions, and therefore the present invention should not be limited to following embodiments.

### First Embodiment

In a first embodiment, a program and a hardware which extracts still image data from moving image data implement an operation according to the present invention. Thus, in the present embodiment, a function which extracts frames with given time periods as still image data from moving image data, specifies a necessary still image data from them, and stores the specified data separately from the moving image data is implemented.

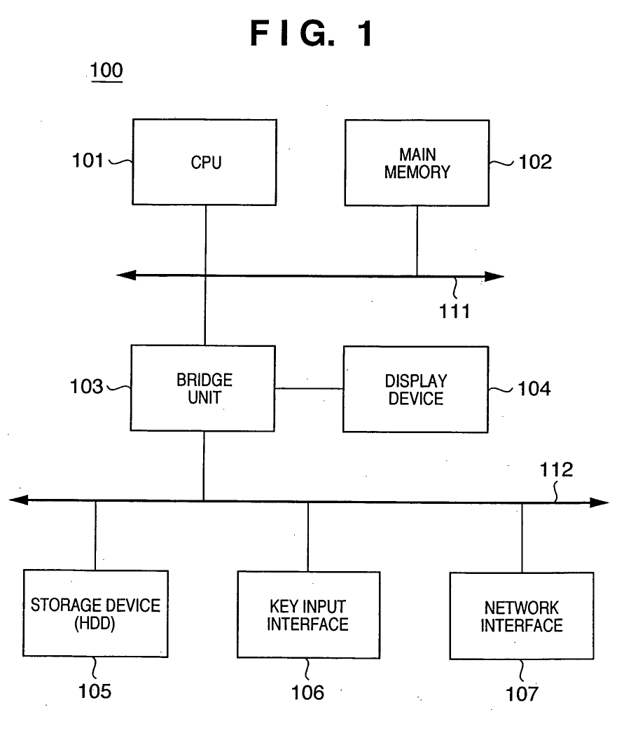

FIG. 1 is a block diagram of a general PC (personal computer) 100 applied as an embodiment according to the present invention.

Reference numeral 101 denotes a CPU (central processing unit). Reference numeral 102 denotes a main memory. Reference numeral 103 denotes a bridge unit which works as a bridge between a main bus 111 and a peripheral bus 112. Reference numeral 104 denotes a display device which is connected with a bridge unit 103 via a graphic port. Reference numeral 105 denotes a mass storage device. In the present embodiment, hard disk drive (HDD) is used as the mass storage. Reference numeral 106 denotes a key input interface (I/F). In the present embodiment, a keyboard and mouse are used as the input operation. Reference numeral 107 denotes a network interface (I/F).

In the present embodiment, an OS (operating system) operates on the PC 100.

The OS has been stored in the storage device 105 here. After the PC is powered on, the OS is loaded into the main memory 102 and sequentially processed at the CPU 101. In addition, the OS controls the bridge unit 103, the display device 104, the storage device 105, the key input I/F 106, and the network I/F 107, and presents a processing result to a user. A program for extracting still image data from moving image data according to the present embodiment is also stored in the storage device 105. In the following description, a representation that a program is executed corresponds to that the CPU 101 of the PC100 Interprets and executes such a relevant program and an instruction of the OS.

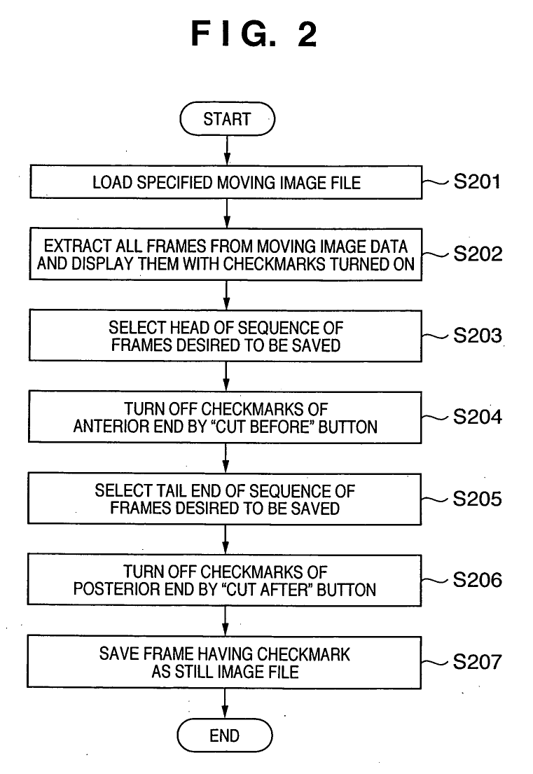

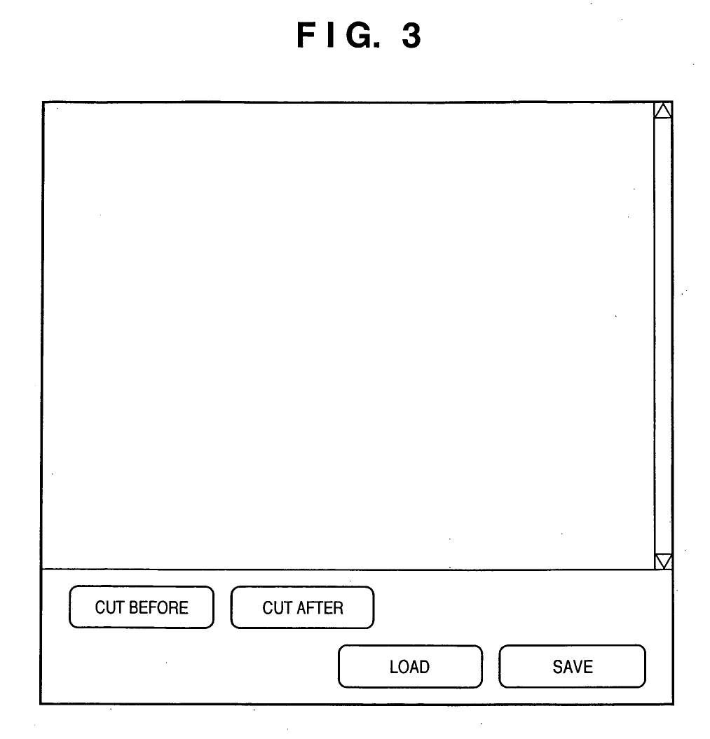

Next, operations of the present embodiment will be described with reference to a flowchart of FIG. 2 and user interface screens of FIG. 3 to FIG. 9.

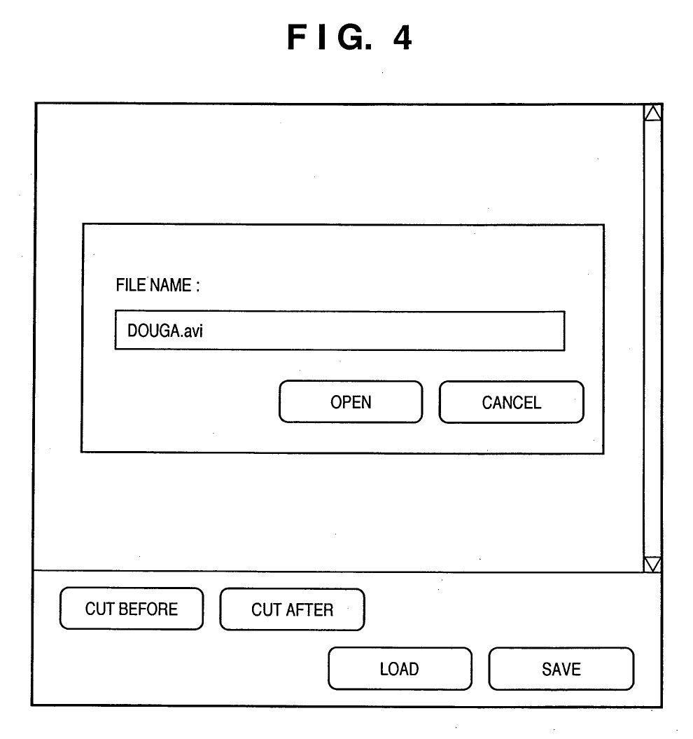

In FIG. 2, when the program is started, the program loads a moving Image file specified by a user from the storage device 105 to the main memory 102 as moving image data at S201. A user interface screen at this point corresponds to FIG. 3 and FIG. 4. FIG. 3 is a screen which is displayed just after the present program is started. A user clicks a “load” button here. When the “load” button is clicked, the program displays a file selection dialogue shown in FIG. 4. The user enters a target file name into the file selection dialogue and clicks an “open” button. When the “open” button is clicked, the program loads the moving image file stored in the storage device 105, and loads it as moving image data into the main memory 102.

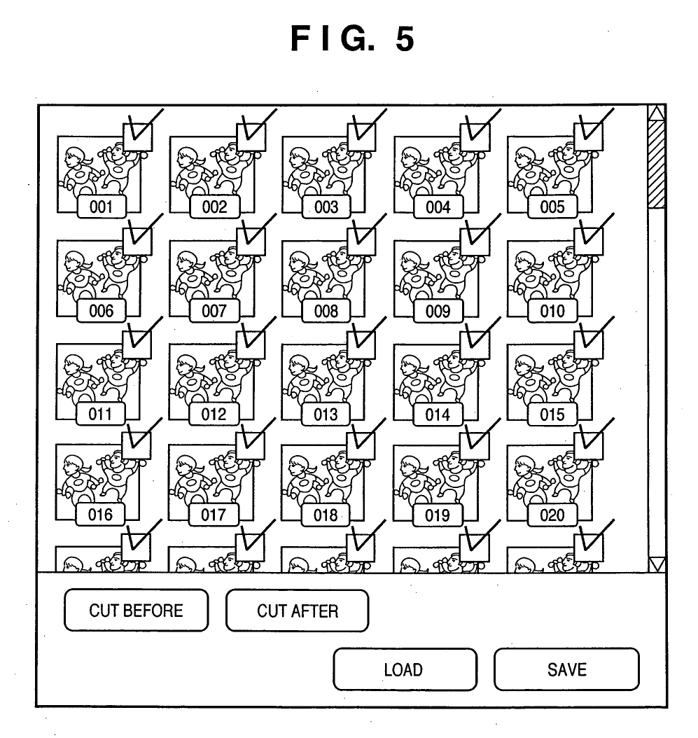

At S202, the program decodes the moving image data loaded into the memory 102, and extracts all frames contained in the moving image data as still image data. A sequence of still image data thus obtained is reduced to make thumbnails, and the thumbnails are displayed in list view on the display device 104. FIG. 5 shows a screen in which thumbnails are displayed in list view. Because these thumbnails are extracted from the moving image, the thumbnails can be displayed in a manner that they are arranged in a sequence along a time axis of the moving image data. In FIG. 5, the thumbnails are arranged in a sequence from top left to bottom right in a rank order, which is indicated by three digit numbers. When a check box which is attached to each thumbnail is ON in FIG. 5, it represents that its corresponding still image data is selected.

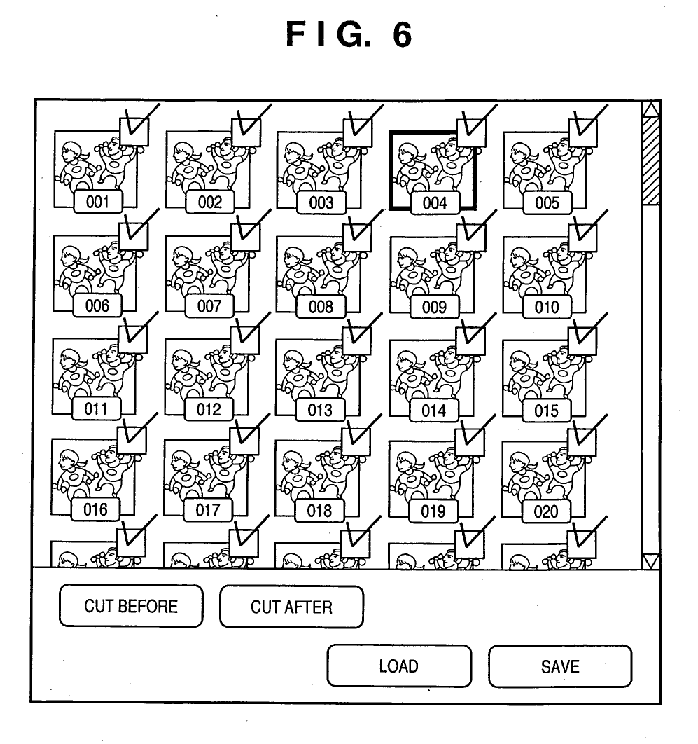

In an operation performed in the present embodiment, when a “save ” button of FIG. 5 is clicked, the program performs a process to save still image data corresponding to a thumbnail whose check box has a checkmark. The user turns on/off such a checkmark to specify target still image data to be saved. Of course, the user can turn on/off checkmarks one by one. However, when a large number of still image data extracted from moving image data are targeted especially as in the present embodiment, it is troublesome to turn off checkmarks one by one. Therefore, in the present embodiment, target thumbnails to be saved are selected from thumbnails displayed on the screen at S203 to S206 of FIG. 2. A user interface screen in the time that such a series of operations are performed is shown in FIG. 5 to FIG. 9. For example, when the user wants to save still image data corresponding to a sequence of thumbnails 004 to 018 in FIG. 5, the user selects a head of the sequence of frames which the user wants to save at S203. This corresponds to clicking and selecting the head thumbnail 004 desired to be selected in the screen of FIG. 5. Additionally, the program displays a screen of the second selected state in which the thumbnail 004 is selected as shown in FIG. 6.

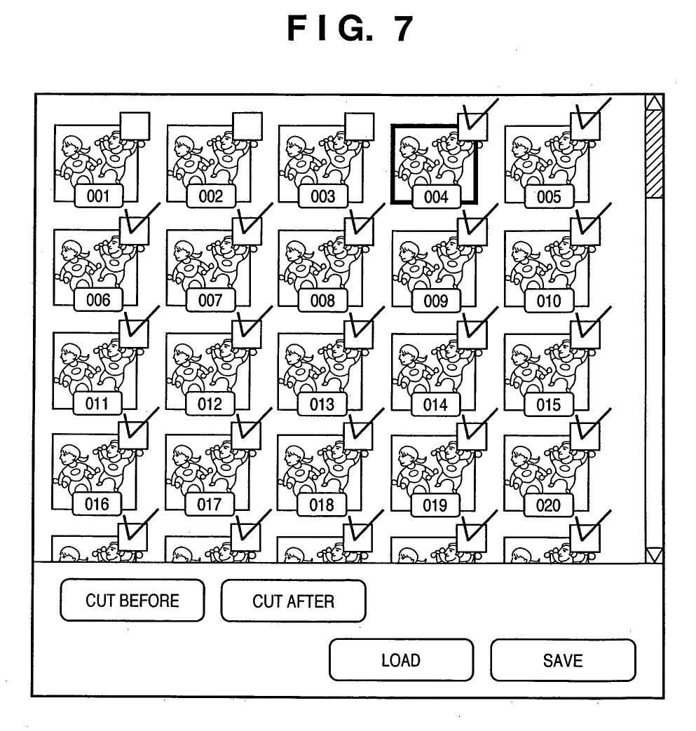

At S204, the user clicks a “cut before” button in the status of FIG. 6. When the “cut before” button is clicked, the program turns off checkmarks of thumbnails 001 to 003 prior to the thumbnail 004. Additionally, the program displays this status by a screen as shown in FIG. 7.

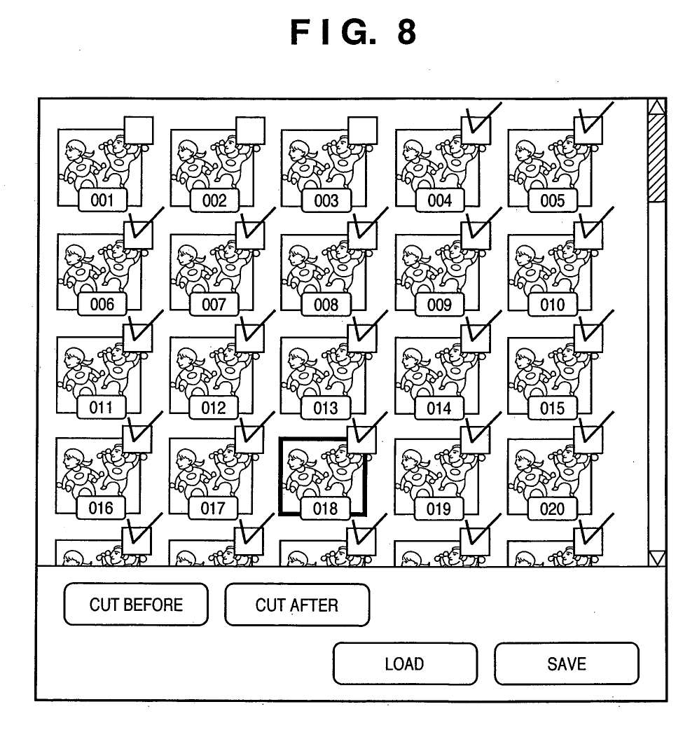

At S205, a tail end of the sequence of frames desired to be saved is selected. In this case, the user clicks the end tail thumbnail 018 of thumbnails desired to be selected to select it from the screen of FIG. 7. Additionally, the program displays a screen of the second selected state in which the thumbnail 018 is selected as shown in FIG. 8.

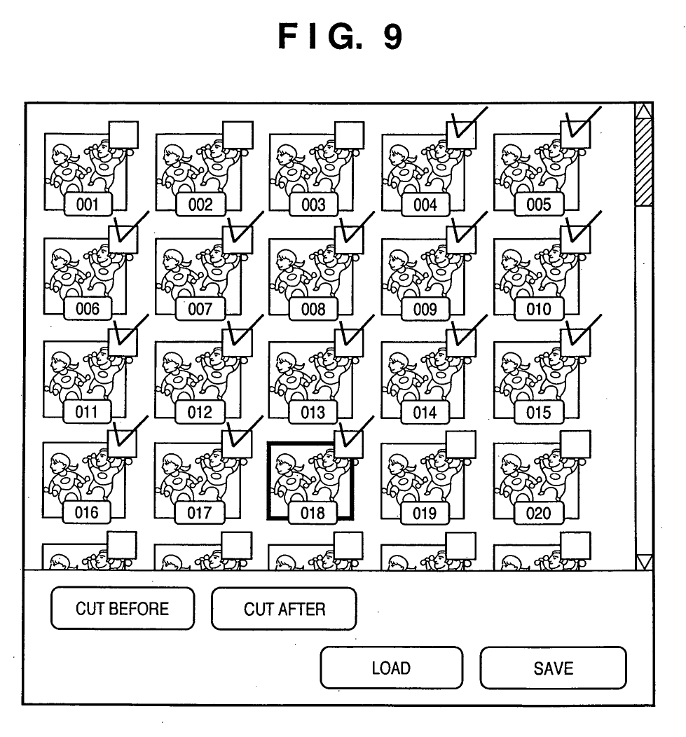

At step S206, the user clicks a “cut after” button in the status of FIG. 8. When the “cut after” button is clicked, the program turns off checkmarks of thumbnail 019 to the last thumbnail after the thumbnail 018. Additionally, the program displays this status by a screen as shown in FIG. 9.

In this way, the user can intuitively know which thumbnails have been selected according to on/off status of each thumbnail displayed on the screen. Then, the user can put desired thumbnails 004 to 018 in selected state intuitively.

At S207, the program saves still image data corresponding to a selected thumbnail as a still image file in the storage device 105. As an operation by the user, the “save” button is clicked in FIG. 9. When the “save” button is clicked, the program obtains still image data corresponding to a thumbnail whose check box is turned on. Then, the program encodes the still image data and saves it as a JPEG format still image file in the storage device 105.

As described above, in the first embodiment, a plurality of still image data (thumbnails) extracted from moving image data are arranged and displayed. And, a checkmark for selecting still image data (thumbnail) desired to be saved from the displayed still image data is provided. Additionally, a “cut before” button and a “cut after” button for turning off checkmarks to cancel them is provided. Thereby, desired still image data (thumbnail) can be intuitively and efficiently selected from a large number of still image data (thumbnails).

### Second Embodiment

In a second embodiment, as in the first embodiment, a program and a hardware which extracts still image data from moving image data implements an operation according to the present invention. However, the second embodiment is different in that a plurality of still image data are selected in the second selected state.

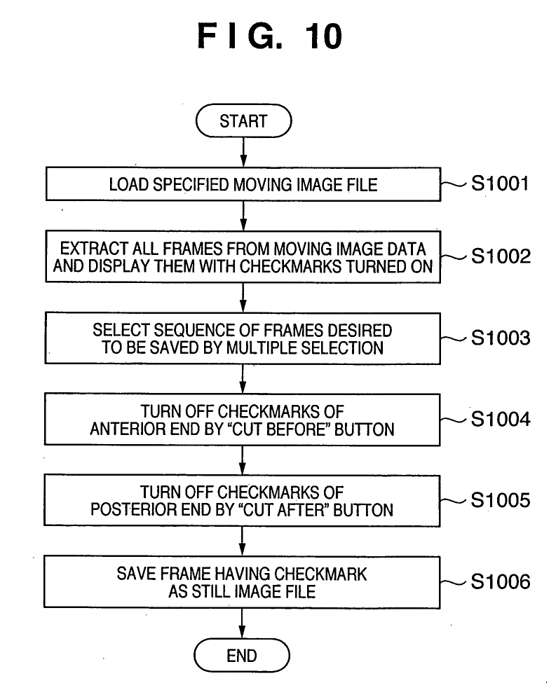

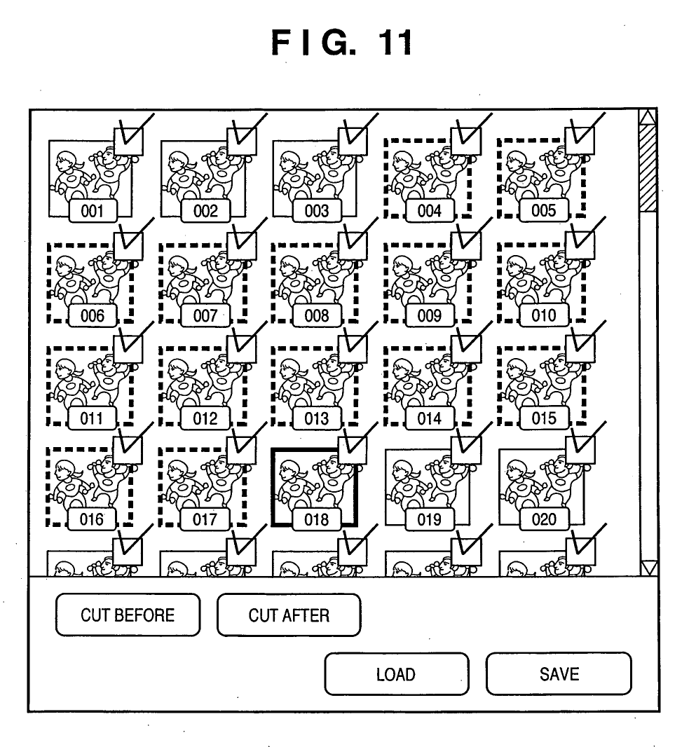

The descriptions about the hardware and the OS described with reference to FIG. 2 are omitted here since they are the same as in the first embodiment. Operations of the present embodiment will now be described with reference to a flowchart of FIG. 10 and user interface screens of FIG. 11 to FIG. 13.

In FIG. 10, when a program is started, the program loads a moving image file specified by a user from the storage device 105 to the main memory 102 as moving image data at S1001. A user interface screen at this point corresponds to FIG. 3 and FIG. 4 as in the first embodiment.

At S1002, the program decodes the moving image data loaded to the main memory 102 to extract all frames as still image data. A sequence of still image data thus obtained is reduced to make thumbnails, and the thumbnails are displayed in list view on the display device 104. A screen at this time is shown in FIG. 5 as with the first embodiment.

At S203 to S205, the user selects thumbnails which the user wants to save from displayed thumbnails. A user interface screen at such time is shown in FIG. 11 to FIG. 13. For example, when the user wants to save still image data corresponding to a sequence of thumbnail 004 to 018, the user selects a sequence of frames at S1003. For selecting a plurality of still image data, there is a method in which a user clicks the thumbnail 018 while pressing a shift key of a keyboard after the user clicks the thumbnail 004, and so on. By a screen as shown in FIG. 11, the program indicates status that a plurality of still image data are selected. In FIG. 11, a heavy solid line and a heavy dotted line correspond to the second selected state.

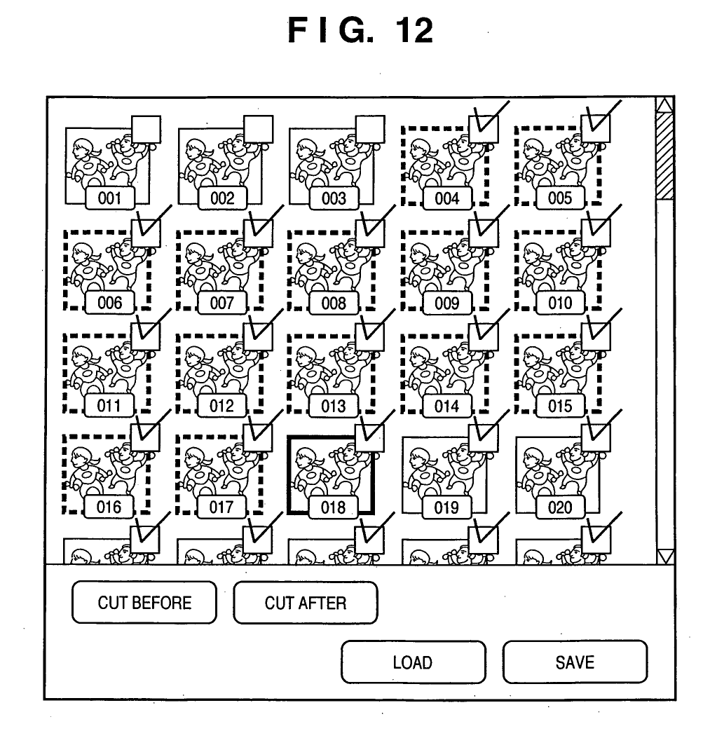

At S1004, the user clicks the “cut before ” button in the status of FIG. 11. When the “cut before” button is clicked, the program turns off checkmarks of thumbnails 001 to 003 prior to the thumbnail 004. Additionally, the program displays this status by a screen as shown in FIG. 12.

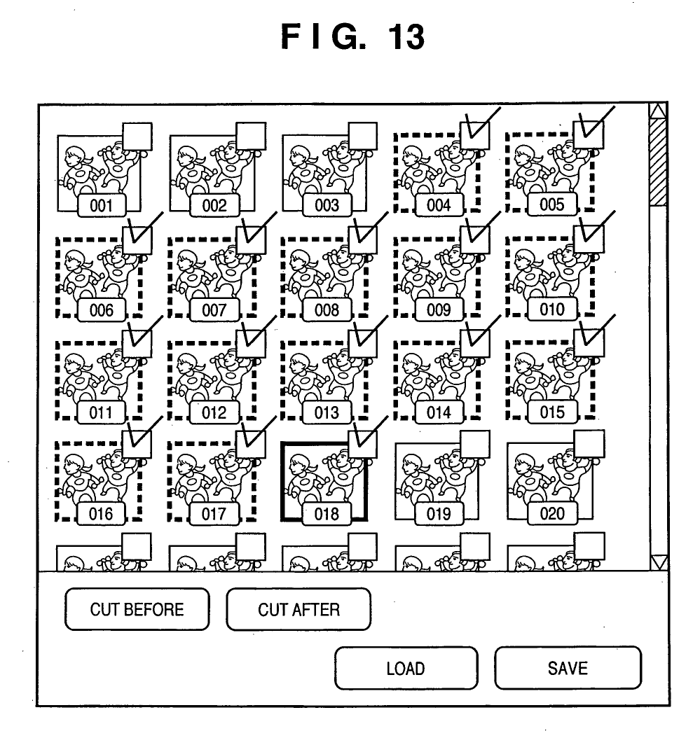

At S1005, the user clicks “cut after” button this time in the state of FIG. 12. When the “cut after ” button is clicked, the program turns off checkmarks of thumbnail 019 to the last thumbnail after the thumbnail 018. Additionally, the program displays this status by a screen as shown in FIG. 13.

In this way, the user can put still image data corresponding to the desired thumbnails 004 to 018in selected state by an intuitive and efficient operation.

At S1006, the selected still image data is saved as a still image file. This operation is the same operation as the first embodiment.

According to the second embodiment described above, a plurality of still image data (thumbnails) extracted from moving image data are arranged and displayed. And, a checkmark for selecting still image data (thumbnail) desired to be saved from the displayed still image data is provided. Additionally, a “cut before” button and a “cut after” button for turning off checkmarks other than still image data selected by multiple selection to cancel them is provided. Thereby, desired still image data (thumbnail) can be intuitively and efficiently selected from a large number of still image data (thumbnails). Although, in the first and second embodiments, an item to be selected is assumed to be still image data (thumbnail) extracted form moving image data, it is not limited to this. For example, it is also applied to a case that consecutive icons are selected in block under status that a plurality of icons are arranged, or a case that consecutive characters are selected in block from a character string.

### Third Embodiment

In a third embodiment, a program and a hardware which saves a sound (audio) file transferred from a recording device connected with the PC 100 to the PC 100 implements an operation according to the present invention.

The descriptions about the hardware and the OS of the computer described with reference to FIG. 2 are omitted here since they are the same as in the first embodiment. On the other hand, the recording device has a microphone circuit, an analog-to-digital conversion circuit, and a storage medium, and is connected to a computer by a communication device such as a USB.

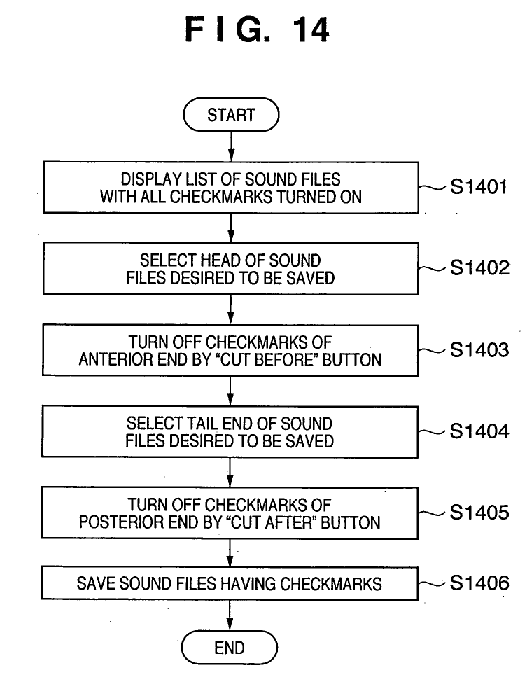

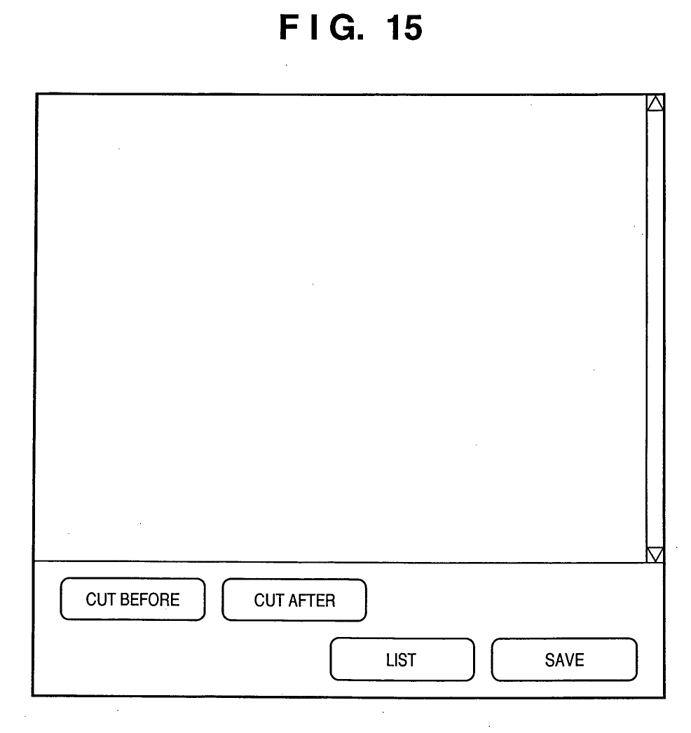

Next, selection operations of the present embodiment will be described with reference to a flowchart of FIG. 14 and user interface screens of FIG. 15 to FIG. 20.

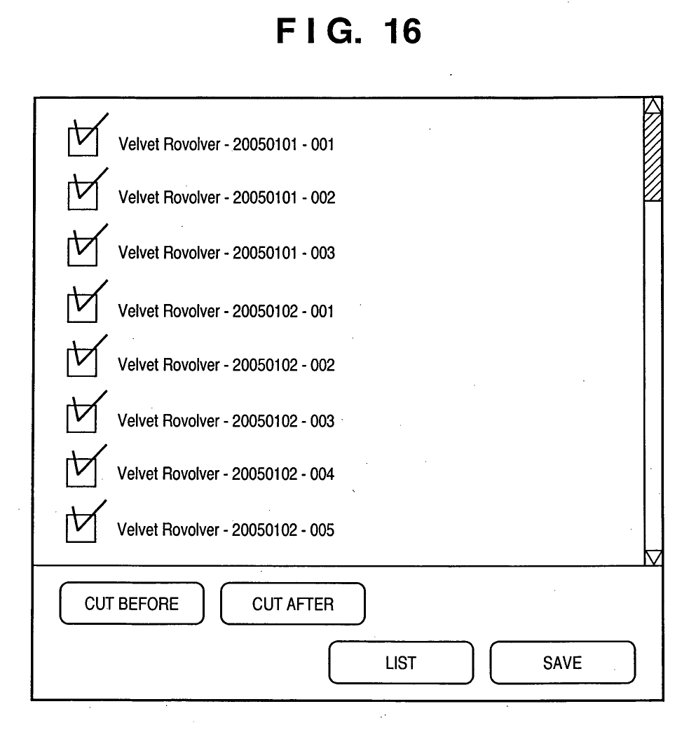

In FIG. 14, when a program is started, the program obtains a list of sound files recorded by the recording device and displays it on the display device at S1401. A user interface screen at this point corresponds to FIG. 15 and FIG. 16. FIG. 15 is a screen which is displayed Just after the present program is started, where the user clicks a “list” button. When the “list” button is clicked, the program obtains a list of sound files from the recording device and displays it in list view on the screen as shown in FIG. 16. Because a sound file has a recorded date/time as attribute information, such a list of sound files can be displayed in a manner that they are arranged in a sequence in order from the oldest one along the times at which they are recorded. In FIG. 16, a check box which is at the left side of each item indicates its corresponding item is selected. An operation performed in the present embodiment is transfer and acquisition of a sound file from the recording device. When a “save” button of FIG. 16 is clicked, the program performs a transfer process on an item whose checkmark in such a check box is on. The user turns on/off such a checkmark to specify an item which is an object of transfer process.

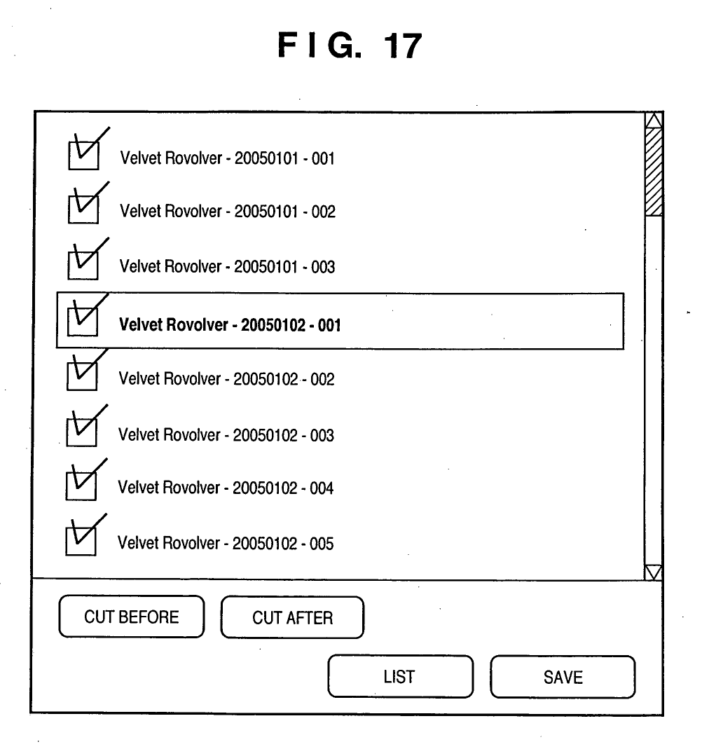

At S1402 to S1405, the user selects an item which the user wants to transfer from displayed items. A user interface screen at this time is shown in FIG. 17 to FIG. 20. For example, it is assumed that the user wants to save a sequence of items from “Velvet Rovolver—20050102-001” to “Velvet Rovolver—20050108-002”. In this case, a head item of the sequence of items is selected at S1402. In a screen shown in FIG. 16, a head item of items desired to be selected “Velvet Rovolver—20050102-001” is clicked and selected. The program displays a screen of the second selected state in which the “Velvet Rovolver—20050102-001” is selected as shown in FIG. 17.

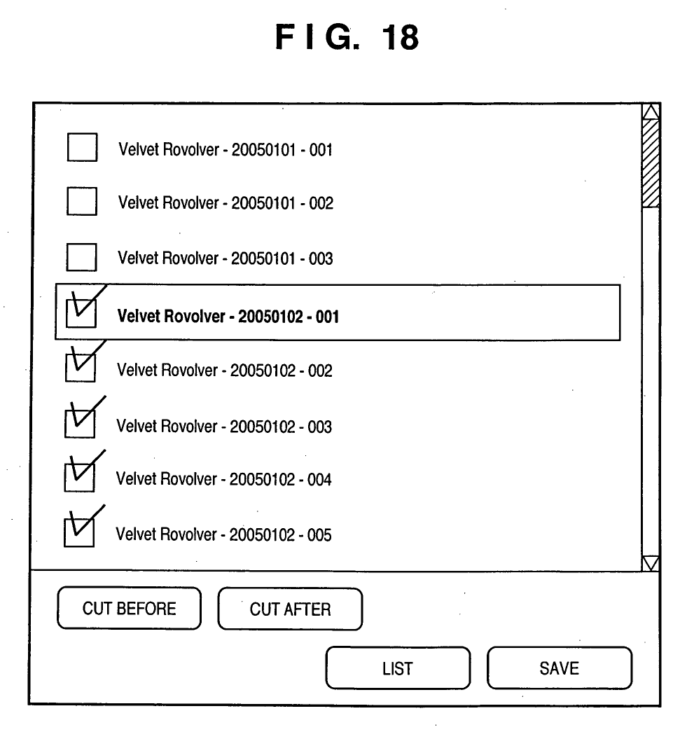

At S1403, the user clicks the “cut before” button in a status of FIG. 17. The program turns off checkmarks of items before the “Velvet Rovolver—20050102-001” here. In other words, checkmarks from the “Velvet Rovolver—20050101-001” to the “Velvet Rovolver-20050101-003” are cancelled. Additionally, the program indicates this status by a screen as shown in FIG. 18.

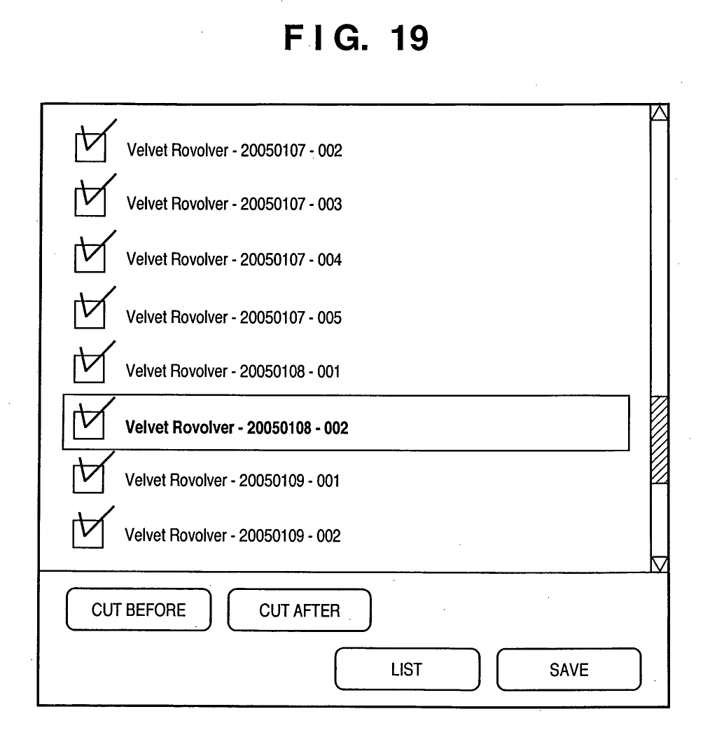

At S1404, the user selects a tail end item of the sequence of items which the user wants to save. In this case, after the user displays an item which the user wants to select by using a scroll bar from the screen shown in FIG. 18, the user clicks the tail end item “Velvet Rovolver-20050108-002” to select it. The program displays a screen of the second selected state in which the “Velvet Rovolver-20050108-002” is selected as shown in FIG. 19.

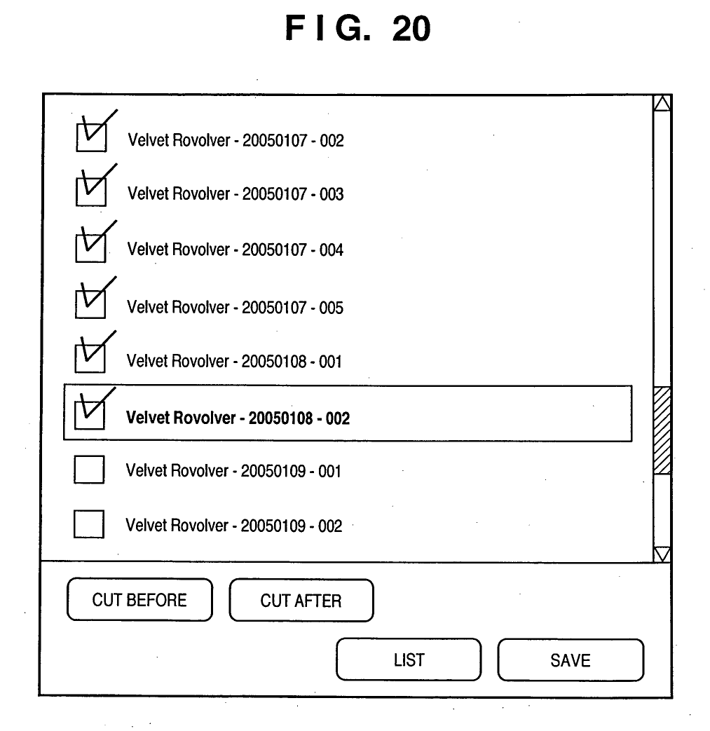

At S1405, the user clicks a “cut after” button in a status of FIG. 19. The program turns off checkmarks of items after the “Velvet Rovolver-20050108-002”. In other words, checkmarks of the “Velvet Rovolver-20050109-001” to the last item are cancelled. Additionally, the program displays this status by a screen as shown in FIG. 20.

In this way, the user can put desired sound files “Velvet Rovolver-20050102-001” to “Velvet Rovolver-20050108-002” in selected state.

At S1406, the program transfers the selected items. As an operation by the user, a “save” button is clicked in FIG. 20. When the “save” button is clicked, the program controls the recording device to transmit items whose checkmarks are on to the computer. Then, the program saves the transmitted sound file in the storage device 105.

According to the third embodiment described above, a list of a plurality of sound files is arranged and displayed. And, a checkmark for selecting a sound file desired to be transferred and saved from the displayed sound files is provided. Additionally, a “cut before” button and a “cut after” button for turning off checkmarks to cancel them is provided. Thereby, desired items can be intuitively and efficiently selected from a large number of items.

### Other Embodiment

Although embodiments according to the present invention have been described in detail using specific examples as above, the present invention can be embodied as, for example, a system, a device, a method, a program, a storage medium (recording medium), and so on. Particularly, the present invention may be applied to a system composed of a plurality of devices or an apparatus composed of one device.

Further, it goes without saying that the object of the present invention may be achieved even if any part of illustrated functional blocks and operations is implemented by a hardware circuit or a software process using a computer.

In addition, the present invention also includes a case that is achieved by supplying a software program for realizing a function of the embodiment described above to a system or a device directly or remotely. In this case, a computer such as a system loads and executes a relevant program code.

Therefore, the program code itself installed in a computer to implement a function process of the present invention by the computer also implements the present invention. In other words, the present invention also includes a computer program itself for realizing the function process of the present invention.

In this case, the program may take a form such as an object code, a program executed by an interpreter, or script data supplied to an OS as long as it has a program function.

Examples of a storage medium (recording medium) for supplying the program are a flexible disk, a hard disk, an optical disk, a magneto-optical disk, an MO, a CD-ROM, a CD-R, a CD-RW, a magnetic tape, a nonvolatile memory card, a ROM, a DVD (DVD-ROM, DVD-R), and so on.

In addition, as a method for supplying the program, the computer program of the present invention itself can be downloaded from a website on the Internet by connecting to the website using a browser of a client computer. The program may also be supplied by downloading a compressed file having auto-install function to a recording device such as a hard disk. The program may also be supplied by dividing a program code constituting the program of the present invention into a plurality of files and downloading the files from different websites. In other words, a WWW server from which the program file for implementing the function process of the present invention by computer is downloaded to a plurality of users is also included in the present invention.

In addition, the program of the present invention may be encrypted, stored in a storage medium such as a CD-ROM to be distributed to users. so that a user who meets a predetermined requirement can download key information for decryption from a website via the Internet. In this case, the encrypted program is executed to be installed in the computer by using the downloaded key information so that the function process of the present invention is implemented.

While the function of the embodiment described above may be implemented by executing a read program by a computer, the function of the embodiment may also be implemented by performing all or a part of the actual process based on an instruction of the program by an OS or the like running on the computer.

Furthermore, the function of the embodiment may also be implemented by performing all or a part of the actual process by a CPU or the like of a function extension board or a function extension unit after the program read from the storage medium is written in a memory of the function extension board inserted into the computer or the function extension unit connected to the computer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-233338, filed Aug. 11, 2005, which is hereby incorporated by reference herein in its entirety.

1.-8. (canceled)

9. An image selection device which selects still image data extracted from moving image data, the extracted still image data being arranged in order based on times at which they are recorded and being displayed in a list view on a display device, comprising:
a first selection unit configured to select a first plurality of still image data from the extracted still image data;
a first display unit configured to display that the first plurality of still image data are in a first selected state selected by the first selection unit;
a second selection unit configured to select second still image data from the first plurality of still image data;
a second display unit configured to display that the second still image data is in a second selected state selected by the second selection unit; and
a cancellation unit configured to cancel the first selected state of at least one of the first plurality of still image data arranged before and at least one of the first plurality of still image data arranged after the second still image data selected by the second selection unit.

10. The image selection device according to claim 1, wherein, if the second still image data selected by the second selection unit are in a plurality, the cancellation unit cancels the first selected state of the first plurality of still image data other than the second still image data.

11. The image selection device according to claim 1, further comprising:
a storage unit configured to store still image data which is in the first or second selected state after cancellation is performed by the cancellation unit, independently from the moving image data.

12. An image selection method for selecting still image data extracted from moving image data, the extracted still image data being arranged in order based on times at which they are recorded and being displayed in a list view on a display device, the method comprising the steps of:
selecting a first plurality of still image data from the extracted still image data;
displaying that the first plurality of still image data are in a first selected state on the display device;
selecting second still image data from the first plurality of still image data;
displaying that the second still image data is in a second selected state on the display device; and
canceling the first selected state of at least one of the first plurality of still image data arranged before and at least one of the first plurality of still image data arranged after the selected second still image data.

13. A computer readable storage medium which stores a program for allowing a computer to select still image data extracted from moving image data, the extracted still image data being arranged in order based on times at which they are recorded and being displayed in a list view on a display device, the program comprising code for:
selecting a first plurality of still image data from the extracted still image data;
displaying that the first plurality of still image data are in a first selected state on the display device;
selecting second still image data from the first plurality of still image data;
displaying that the second still image data is in a second selected state on the display device; and
canceling the first selected state of at least one of the first plurality of still image data arranged before and at least one of the first plurality of still image data arranged after the selected second still image data.

14. A computer program product stored on a computer-readable memory medium and embodying a computer-executable program for selecting still image data extracted from moving image data, the extracted still image data being arranged in order based on times at which they are recorded and being displayed in a list view on a display device, comprising:
selecting a first plurality of still image data from the extracted still image data;
displaying that the first plurality of still image data are in a first selected state on the display device;
selecting second still image data from the first plurality of still image data;
displaying that the second still image data is in a second selected state on the display device; and
canceling the first selected state of at least one of the first plurality of still image data arranged before and at least one of the first plurality of still image data arranged after the selected second still image data.
